(19) United States
(12) Patent Application Publication
(10) Pub. No.: US 2022/0415333 A1
(43) Pub. Date: Dec. 29, 2022

(54) USING AUDIO WATERMARKS TO IDENTIFY CO-LOCATED TERMINALS IN A MULTI-TERMINAL SESSION

(71) Applicant: Tencent Technology (Shenzhen) Company Limited, Shenzhen (CN)

(72) Inventors: Rui ZHU, Shenzhen (CN); Yuepeng LI, Shenzhen (CN); Shidong SHANG, Shenzhen (CN)

(73) Assignee: Tencent Technology (Shenzhen) Company Limited, Shenzhen (CN)

(21) Appl. No.: 17/901,682

(22) Filed: Sep. 1, 2022

Related U.S. Application Data
(63) Continuation of application No. PCT/CN2021/102925, filed on Jun. 29, 2021.

(30) Foreign Application Priority Data
Aug. 18, 2020 (CN) 202010833586.5

(51) Int. Cl. G10L 19/018; G10L 25/21; G10L 25/51

(52) U.S. Cl. CPC G10L 19/018; G10L 25/21; G10L 25/51

(57) ABSTRACT

An audio playing method is performed by a first terminal participating in a group communication session. The method includes obtaining first audio data of the group communication session, and adding an audio watermark to the first audio data to obtain second audio data. The audio watermark includes on a session identifier of the group communication session and a device identifier of the first terminal. The method also includes playing the second audio data.

### RELATED APPLICATIONS

This application is a continuation of International Application No. PCT/CN2021/102925, filed on Jun. 29, 2021, which claims priority to Chinese Patent Application No. 202010833586.5, entitled “GROUP SESSION-BASED AUDIO PLAYING AND DEVICE MANAGEMENT METHOD AND APPARATUS” filed on Aug. 18, 2020. The entire disclosures of the prior applications are hereby incorporated by reference.

### FIELD OF THE TECHNOLOGY

This application relates to the field of audio data processing, including an audio playing method and apparatus, a device management method and apparatus, and a computer device.

### BACKGROUND OF THE DISCLOSURE

With the development of Internet technology and cloud computing technology, group communication sessions relying on the Internet and cloud servers are becoming increasingly popular. In a group communication session scenario, when a user is speaking, a terminal used by the user sends acquired audio data to a cloud server, and the cloud server distributes the audio data to terminals used by other users.

### SUMMARY

Embodiments of this disclosure provide an audio playing method and apparatus, a device management method and apparatus, and a computer device. The technical solutions are as follows.

In an embodiment, an audio playing method is performed by a first terminal participating in a group communication session. The method includes obtaining first audio data of the group communication session, and adding an audio watermark to the first audio data to obtain second audio data. The audio watermark includes on a session identifier of the group communication session and a device identifier of the first terminal. The method also includes playing the second audio data.

In an embodiment, a device management method is performed by a second terminal. The method includes acquiring, by the second terminal, audio data, the second terminal being a terminal participating in a group communication session. The method also includes performing watermark detection on the acquired audio data, and determining, in response to detection of an audio watermark in the acquired audio data, that the second terminal and another terminal identified by the detected audio watermark are in a same physical space. The method further includes displaying first prompt information, the first prompt information instructing to disable a voice function of the second terminal.

In an embodiment, an audio playing method is performed by a server. The method includes receiving a watermark detection result and audio data acquired by a second terminal, the second terminal being a terminal participating in a group communication session. The method also includes determining, based on the watermark detection result, that a first terminal among participating terminals of the group communication session is in a same physical space as the second terminal. The method further includes forwarding the audio data to other participating terminals of the group communication session, the other participating terminals being configured to play the audio data, and the other participating terminals being terminals other than the second terminal and the first terminal.

In the technical solutions provided in the embodiments of this disclosure, an audio watermark is added to to-be-played audio data during a group communication session based on cloud technology. Because the audio watermark is associated with a device identifier of a terminal, the audio watermark can be used for indicating which terminal the audio data is played by. That is, it may be determined according to the audio watermark that a terminal that acquires the audio data and the terminal that plays the audio data are in the same physical space, which is convenient for users to perform subsequent device management.

### BRIEF DESCRIPTION OF THE DRAWINGS

To describe the technical solutions of the embodiments of this disclosure, the following briefly introduces the accompanying drawings describing the embodiments. The accompanying drawings in the following description show only some embodiments of this disclosure, and a person of ordinary skill in the art may still derive other drawings from these accompanying drawings.

FIG. 1 is a schematic diagram of an implementation environment of a group session according to an embodiment of this disclosure.

FIG. 2 is a schematic diagram of an audio watermark loading and identification process according to an embodiment of this disclosure.

FIG. 3 is a flowchart of an audio playing method according to an embodiment of this disclosure.

FIG. 4 is a schematic diagram of a watermark loading unit according to an embodiment of this disclosure.

FIG. 5 is a schematic structural diagram of a source data frame according to an embodiment of this disclosure.

FIG. 6 is a schematic structural diagram of a channel-coded frame according to an embodiment of this disclosure.

FIG. 7 is a schematic diagram of a watermark loading method according to an embodiment of this disclosure.

FIG. 8 is a schematic diagram of a watermark loading method according to an embodiment of this disclosure.

FIG. 9 is a flowchart of a device management method according to an embodiment of this disclosure.

FIG. 10 is a schematic diagram of a watermark parsing unit according to an embodiment of this disclosure.

FIG. 11 is a schematic diagram of a session interface according to an embodiment of this disclosure.

FIG. 12 is a flowchart of forwarding and playing audio data according to an embodiment of this disclosure.

FIG. 13 is a schematic diagram of another session interface according to an embodiment of this disclosure.

FIG. 14 is a schematic diagram of still another session interface according to an embodiment of this disclosure.

FIG. 15 is a schematic structural diagram of an audio playing apparatus according to an embodiment of this disclosure.

FIG. 16 is a schematic structural diagram of a device management apparatus according to an embodiment of this disclosure.

FIG. 17 is a schematic structural diagram of an audio playing apparatus according to an embodiment of this disclosure.

FIG. 18 is a schematic structural diagram of a terminal according to an embodiment of this disclosure.

FIG. 19 is a schematic structural diagram of a server according to an embodiment of this disclosure.

### DESCRIPTION OF EMBODIMENTS

To make the objectives, technical solutions, and advantages of this disclosure clearer, the following further describes implementations of this disclosure in detail with reference to the accompanying drawings. The described embodiments are some rather than all the embodiments of this disclosure. All other embodiments obtained by a person of ordinary skill in the art based on the embodiments of this disclosure shall fall within the protection scope of this disclosure.

Terms such as “first” and “second” in this disclosure are used for distinguishing between same items or similar items that have basically same functions and purposes. It is to be understood that “first”, “second”, and “nth” do not have any dependency relationship in logic or in a time sequence, and do not limit a quantity or an execution sequence.

Cloud technologies are a general term for a network technology, an information technology, an integration technology, a management platform technology, an application technology, and the like applied based on the business mode of cloud computing, and may form a resource pool used on demand flexibly and conveniently.

The technical solutions provided in the embodiments of this disclosure can be applied to cloud conference scenarios. The cloud conference is an efficient, convenient, and low-cost conference form based on the cloud computing technology. Users only need to perform simple and easy operations through Internet interfaces, and can quickly, efficiently, and synchronously share speech, data files, and videos with teams and customers around the world. Complex technologies such as data transmission and processing in conferences are provided by a cloud conference service provider to assist the users in operations. Currently, domestic cloud conferences mainly focus on service content of a software as a service (SaaS) mode, including calls, networks, videos, and other service forms. Conferences based on the cloud computing are referred to as cloud conferences. In an era of cloud conferences, data transmission, processing, and storage are all performed by computer resources of cloud conference service providers. The users do not need to purchase expensive hardware or install cumbersome software at all. The users only need to open browsers and log in to corresponding interfaces to conduct efficient teleconferences. A cloud conference system supports multi-server dynamic cluster deployment and provides a plurality of high-performance servers, which greatly improves stability, security, and availability of conferences.

FIG. 1 is a schematic diagram of an implementation environment according to an embodiment of this disclosure. Referring to FIG. 1, the implementation environment includes at least two terminals 101 and a server 102 (only two terminals 101 are taken as an example in FIG. 1).

The at least two terminals 101 are both user-side devices, and the at least two terminals 101 are installed with and run a target application supporting group sessions. For example, the target application is a social application, an instant messaging application, or the like. In this embodiment of this disclosure, the at least two terminals 101 are terminals participating in a same session. The at least two terminals 101 may be a smart phone, a tablet computer, a notebook computer, an e-book reader, a Moving Picture Experts Group Audio Layer III (MP3) player, a Moving Picture Experts Group Audio Layer IV (MP4) player, a laptop portable computer, a desktop computer, or the like, which is not limited in this embodiment of this disclosure.

The server 102 is configured to provide backend services for the target application running on the at least two terminals 101, for example, to provide support for group sessions. The server 102 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The at least two terminals 101 and the server 102 may be directly or indirectly connected through wired or wireless communication, which is not limited in this embodiment of this disclosure.

Taking the at least two terminals 101 including a first terminal and a second terminal described above as an example, the implementation environment described above constitutes a device management system. In the device management system, the first terminal and the second terminal are terminals participating in a target session (group communication session).

The first terminal is configured to obtain to-be-played first audio data (first audio data of the group communication session); add an audio watermark to the first audio data to obtain second audio data, the audio watermark being determined based on (or including) a session identifier of the target session and a device identifier of the first terminal; and play the second audio data.

The second terminal is configured to acquire audio data, and perform watermark detection on the audio data in response to the acquired audio data; determine, in response to detecting that the audio watermark exists in the audio data, that the second terminal and the first terminal corresponding to the audio watermark are in a same space; and display first prompt information, the first prompt information being used for instructing to disable a voice function of the second terminal.

The second terminal is further configured to process the audio data based on a watermark detection result; and transmit the watermark detection result and the processed audio data to the server.

The server is configured to receive the watermark detection result and the audio data transmitted by the second terminal; determine, based on the watermark detection result, that a target terminal (first terminal) exists in participating terminals of the target session (the group communication session), the target terminal and the second terminal being in a same space (same physical space); and forward the audio data to other participating terminals of the target session, the other participating terminals being configured to play the audio data, and the other participating terminals being terminals other than the second terminal and the target terminal.

In the device management system described above, the first terminal, the second terminal, and the server cooperate with each other to jointly manage the target session, avoid echo and howling in the target session, and improve the session quality of the target session.

Considering that in the group session scenario described above, in a case that a plurality of users are in a same room, and microphones of terminals of the plurality of users have been turned on, the microphones repeatedly acquire the content played by speakers of the terminals of other users. In this case, echo and howling are generated, which seriously affects the session quality. Therefore, in a group session scenario, it is an important research direction to accurately determine which terminals are in a same space, so as to prevent an audio played by a speaker of a terminal in the same space from being repeatedly acquired by microphones of other terminals, avoid echo and howling during the session, and improve the session quality.

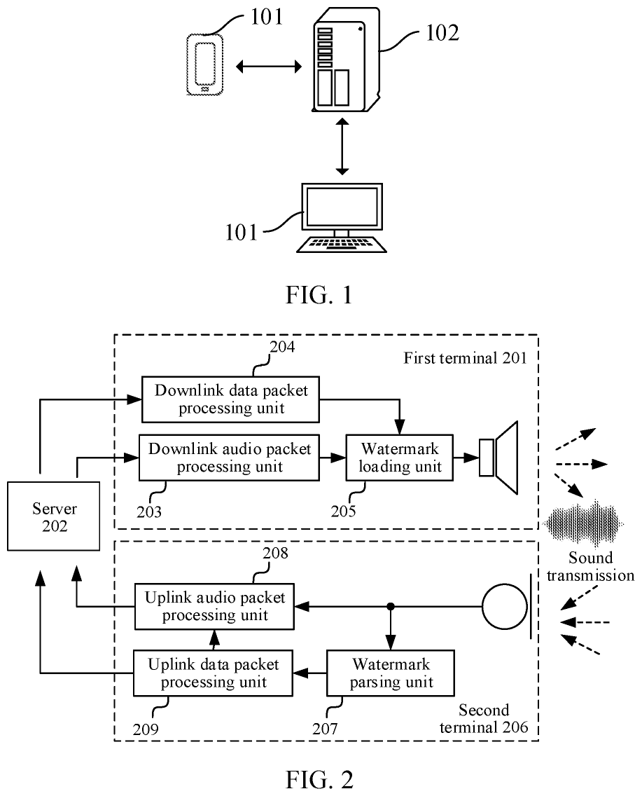

An embodiment of this disclosure provides an audio playing method and a device management method, in which a plurality of terminals in a same space in a group session are accurately located based on audio watermarks, and the device management is performed on the plurality of terminals, so that echo and howling due to close distances among the plurality of terminals in a group session scenario are avoided, and the session quality of the group session is improved. The technical solutions provided in the embodiments of this disclosure may be combined with various scenarios, for example, may be applied to cloud conference scenarios, online teaching scenarios, telemedicine scenarios, or the like. FIG. 2 is a schematic diagram of an audio watermark loading and identification process according to an embodiment of this disclosure. This embodiment of this disclosure is briefly described below with reference to FIG. 2. In this disclosure, a first terminal 201 participating in a target session inputs first audio data obtained from a server 202 into a downlink audio packet processing unit 203, and the downlink audio packet processing unit 203 performs audio decoding, network jitter processing, sound mixing, sound beautification, and the like, on the first audio data. The first terminal 201 inputs an obtained data packet into a downlink data packet processing unit 204, the data packet includes a session identifier of the target session and a device identifier of the first terminal, and the downlink data packet processing unit 204 outputs a watermark text based on the data packet. A watermark loading unit 205 adds the watermark text to audio data outputted by the downlink audio packet processing unit 203, to obtain second audio data with an audio watermark added, and the second audio data is played by a speaker of the first terminal 201. In addition, a second terminal 206 participating in the target session acquires audio data, and the second terminal inputs the acquired audio data into a watermark parsing unit 207 and an uplink audio packet processing unit 208. The second terminal extracts the watermark text from the audio data through the watermark parsing unit 207, and inputs a parsed watermark text into an uplink data packet processing unit 209. The uplink data packet processing unit 209 performs data analysis on the watermark text, to obtain a watermark analysis result, that is, determines whether there is a terminal in a same space as the second terminal among terminals participating in the target session. In this embodiment of this disclosure, in a case that there is a terminal in the same space as the second terminal, the second terminal may display prompt information, to prompt a user to mute the voice or use an earphone. In this embodiment of this disclosure, the uplink audio packet processing unit 208 may optimize the acquired audio data based on a watermark detection result outputted by the uplink data packet processing unit 209. The second terminal 206 transmits the optimized audio data and the watermark detection result to the server 202, and the server 202 forwards the data. In this embodiment of this disclosure, the server 202 may also transmit prompt information to an administrator terminal based on the watermark detection result, so as to prompt an administrator to perform device management on a plurality of terminals in the same space. By applying the technical solutions provided in the embodiments of this disclosure, in a case that it is detected that a plurality of terminals are in a same space, prompt information is displayed on the plurality of terminals, to prompt users to mute the voice or use earphones, so that the sound played by a specific terminal is repeatedly acquired by other terminals in the same space is avoided, and echo and howling in a session are eliminated, thereby improving the session quality of a group session.

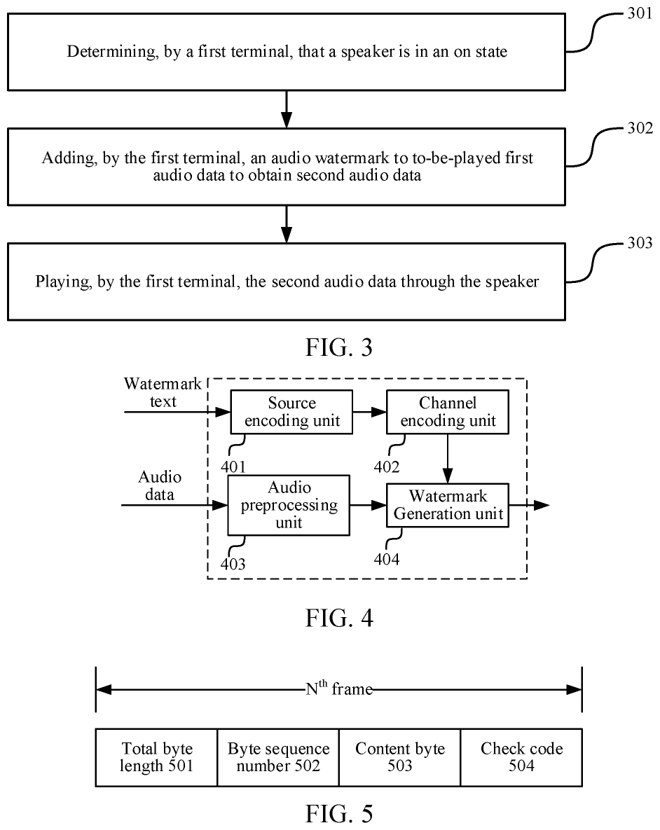

FIG. 3 is a flowchart of an audio playing method according to an embodiment of this disclosure. The method may be applied to the implementation environment described above. In this embodiment of this disclosure, a process of adding a watermark to audio data described above is executed by a first terminal. Referring to FIG. 3, this embodiment may include the following steps.

In step 301 it is determined, by the first terminal, that a speaker is in an on state.

In this embodiment of this disclosure, the first terminal is any terminal participating in a target session, and the target session is a group session. During a session, a first user performs voice input through a voice input device such as a microphone of the first terminal, the first terminal transmits acquired audio data to a server, and the server forwards the audio data, so that other terminals participating in the target session can obtain the audio data acquired by the first terminal. The first terminal may also obtain and play audio data acquired by the other terminals from the server.

In a possible implementation, after a first terminal participates in a target session, a speaker may be detected, and in response to that the speaker is in an on state, that is, the first terminal is in an audio playing state, audio data can be played. In addition, to facilitate the identification of other terminals in a same space as the first terminal, the first terminal needs to add a watermark to the audio data before playing the audio data, that is, perform the following step 302. In this way, in a case that the other terminals in the same space as the first terminal acquire the audio data played by the first terminal, the audio data includes a watermark that can indicate an identity of the first terminal. In response to that the speaker is in an off state, or the first terminal is connected to an earphone, the first terminal may directly play the audio data through the earphone, that is, the following step 302 of adding an audio watermark does not need to be performed.

In step 302, to-be-played first audio data is obtained by the first terminal, and an audio watermark is added to the to-be-played first audio data to obtain second audio data.

The first audio data is audio data obtained by the first terminal from the server. The audio watermark is determined based on a session identifier of the target session and a device identifier of the first terminal. In a case that any terminal performs watermark detection on audio data after adding an audio watermark, it may determine which terminal plays the audio data based on the audio watermark. The session identifier is used for uniquely identifying a session, and the device identifier is used for uniquely identifying a terminal participating in the session. In a possible implementation, in a case of creating a target session, a server may assign a session identifier to the target session, and assign a device identifier to each terminal participating in the target session. Certainly, an identifier of a user account logged in a terminal may also be used as a device identifier of the terminal, so that each terminal is marked with the identifier of the user account logged in the terminal, which is not limited in this embodiment of this disclosure. In this embodiment of this disclosure, description is made by taking the assignment of a device identifier to each terminal as an example.

In a possible implementation, the step 302 described above may be implemented by a watermark loading unit in the first terminal. FIG. 4 is a schematic diagram of a watermark loading unit according to an embodiment of this disclosure. Referring to FIG. 4, the watermark loading unit includes a source encoding unit 401, a channel encoding unit 402, an audio preprocessing unit 403, and a watermark generation unit 404. A process of adding an audio watermark in first audio data is described below with reference to FIG. 4.

In Step 1, a watermark text is obtained by a first terminal based on a session identifier of a target session and a device identifier of the first terminal.

For example, the first terminal may splice the session identifier of the target session and the device identifier of the first terminal, to obtain the watermark text. Certainly, the watermark text may also include other information, which is not limited in this embodiment of this disclosure.

In Step 2, source coding and channel coding are performed by the first terminal on the watermark text to obtain a watermark sequence.

The watermark sequence may be represented as a binary bit sequence.

In a possible implementation, after obtaining a watermark text, a first terminal first performs source coding on the watermark text. For example, first, the first terminal determines a byte length of the watermark text; then, splits the watermark text into content byte packets of length in bytes; and finally, adds a total byte length of the watermark text and a byte sequence number of a current content byte packet to a packet header of each of the content byte packets, and adds a check code to a packet trailer of the each of the content byte packets to obtain a source data frame. The check code may be a 32-bit cyclic redundancy check (CRC) code, a parity check code, or a block check code, or the like, which is not limited in this embodiment of this disclosure. FIG. 5 is a schematic structural diagram of a source data frame according to an embodiment of this disclosure. Referring to FIG. 5, a source data frame includes a total byte length 501 of a watermark text, a byte sequence number 502, a content byte 503, and a check code 504.

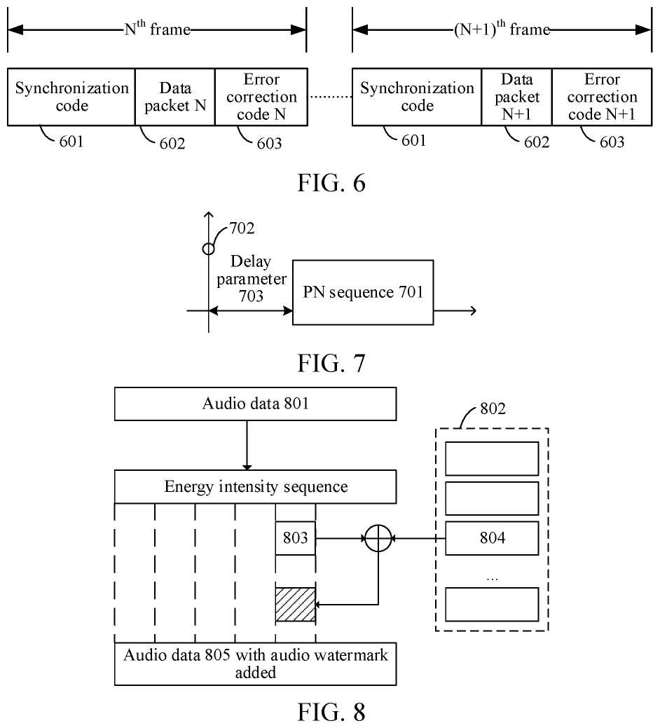

In a possible implementation, the first terminal performs channel coding on each source data frame, so as to improve the identification rate of a subsequent watermark parsing process and the robustness of data transmission. For example, the first terminal adds a synchronization code to a packet header of the each source data frame, and adds an error correction code to a packet trailer, to obtain a channel-coded frame, that is, to obtain a watermark sequence. The synchronization code is a preset reference code sequence, which is used for frame synchronization during data transmission. The length and specific content of the reference code sequence are set by a developer, which is not limited in this embodiment of this disclosure. For example, the synchronization code may be a 13-bit Barker code. The error correction code is used for reducing the bit error rate of a receiving end in a case that a channel signal-to-noise ratio is poor. The length and specific content of the error correction code may be set by the developer, which is not limited in this embodiment of this disclosure. For example, the error correction code may be a 63-bit Bose, Ray-Chaudhuri, Hocquenghem (BCH) code. FIG. 6 is a schematic structural diagram of a channel-coded frame according to an embodiment of this disclosure. Referring to FIG. 6, each channel-coded frame includes a synchronization code 601, a data packet 602 corresponding to a source data frame, and an error correction code 603.

The foregoing description of the methods for source coding and channel coding is only an exemplary description, and the method used for performing the source coding and the channel coding is not specifically limited in the embodiments of this disclosure. In this embodiment of this disclosure, communication quality improvement methods such as synchronization, error detection, and error correction are applied in source coding and channel coding stages, to reduce the bit error rate of subsequent data transmission and improve the efficiency and accuracy of subsequent watermark detection.

In this embodiment of this disclosure, a channel encoding unit needs to transmit channel-coded frames to a watermark generation unit, and the watermark generation unit determines a watermark sequence based on data in the channel-coded frames. In a possible implementation, because packet loss and bit error may occur during data transmission, the channel encoding unit may cyclically and repeatedly transmit channel-coded frames to the watermark generation unit, and the watermark generation unit performs data deduplication and data splicing based on packet header and packet trailer information of the channel-coded frames, so as to obtain a complete and accurate watermark sequence.

In Step 3, the watermark sequence is loaded by the first terminal into the first audio data to obtain second audio data.

In a possible implementation, the first terminal obtains an energy spectrum envelope of the first audio data through an audio preprocessing unit, and the energy spectrum envelope may be used for indicating an energy intensity of each audio frame. The first terminal determines at least one watermark loading position in the first audio data based on the energy spectrum envelope of the first audio data. For example, the first terminal compares the energy spectrum envelope of the first audio data with a reference threshold, and determines a position corresponding to an energy spectrum envelope greater than the reference threshold in the first audio data as the at least one watermark loading position. The reference threshold may be set by a developer, which is not limited in this embodiment of this disclosure. In this embodiment of this disclosure, a position with a high energy intensity in audio data is determined as a watermark loading position, and the watermark loading is performed, which can effectively avoid the interference of an audio watermark on an audio with low energy, and avoid the loss of effective information of an audio frame, thereby ensuring the accuracy of a subsequent decoding process.

In this embodiment of this disclosure, the first terminal loads the watermark sequence at the at least one watermark loading position to obtain the second audio data. In a possible implementation, the first terminal may load an audio watermark in a time domain based on the time-domain masking characteristics of a human ear, and convert a watermark sequence into early reflection sounds with different delays, thereby hiding the watermark sequence in an audio data, that is, a time-domain watermark generation technology based on echo concealment is applied. FIG. 7 is a schematic diagram of a watermark loading method according to an embodiment of this disclosure. Referring to FIG. 7, description is made by taking an example in which an audio watermark is loaded at a watermark loading position. For example, a first terminal may first encrypt a watermark sequence, convert each element in the watermark sequence into a Pseudo-Noise Code (PN) sequence 701, and for an element in the watermark sequence, based on a watermark loading position 702 and a delay parameter 703 corresponding to the element, insert a PN sequence of the element into audio data. Different elements may correspond to different delay parameters, and the delay parameters and correspondence among the delay parameters and elements are all set by a developer, which is not limited in this embodiment of this disclosure.

In a possible implementation, the first terminal may load an audio watermark in a transform domain based on the frequency-domain masking characteristics of a human ear, and convert a watermark sequence into energy fluctuations on sub-bands of different frequencies, thereby hiding the watermark sequence in audio data, that is, the discrete cosine transform (DCT) domain watermark generation technology based on the spread spectrum principle is applied. FIG. 8 is a schematic diagram of a watermark loading method according to an embodiment of this disclosure. Referring to FIG. 8, for example, a first terminal performs DCT domain transformation on audio data 801 to obtain an energy intensity sequence corresponding to the audio data 801. The first terminal performs encryption processing on a watermark sequence, and converts each element in the watermark sequence into a Pseudo-Noise Code (PN) sequence 802. Then, the first terminal obtains, based on a determined watermark loading position, an element 803 corresponding to the watermark loading position from the energy intensity sequence, multiplies the element 803 with an element 804 in the watermark sequence, and loads a multiplication result into the audio data, to obtain audio data 805 to which an audio watermark has been added.

The foregoing description of the method for adding an audio watermark to the first audio data is only an exemplary description, and the method used for adding an audio watermark is not specifically limited in the embodiments of this disclosure. Certainly, before adding an audio watermark to the first audio data, the first terminal may also perform post-processing enhancement processing such as network damage repair and sound beautification on the first audio data, which is not limited in this embodiment of this disclosure.

In step 303, the second audio data is played by the first terminal through the speaker.

In this embodiment of this disclosure, after obtaining the second audio data to which an audio watermark is added, the first terminal may play the second audio data through a speaker.

In the technical solutions provided in the embodiments of this disclosure, an audio watermark that is inaudible to a human ear is added to to-be-played audio data during a session. Because the audio watermark is associated with a device identifier of a terminal, the audio watermark can be used for indicating which terminal the audio data is played by. That is, it may be determined according to the audio watermark that a terminal that acquires the audio data and the terminal that plays the audio data are in a same space, which is convenient for users to perform subsequent device management.

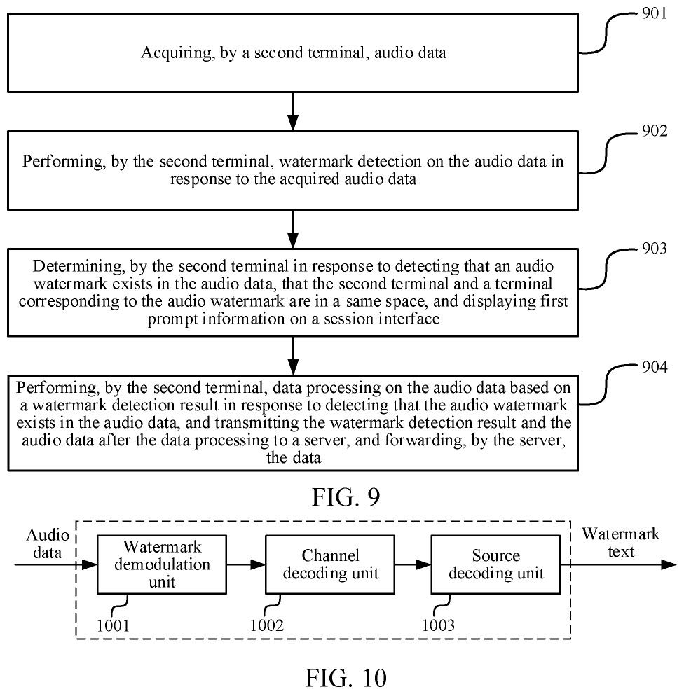

The process of adding an audio watermark to audio data is mainly described in the foregoing embodiments. In this embodiment of this disclosure, because the audio watermark is associated with a device identifier of a terminal, during a session, the terminal may perform watermark detection on acquired audio data, to determine whether the acquired audio data includes audio data that has been played by other terminals and which terminal the audio data is played by, and then prompt a user to manage a device, for example, prompting the user to mute the terminal or use an earphone to avoid acquiring the audio data played by other terminals in a same space, so as to avoid echo and howling in a group session. FIG. 9 is a flowchart of a device management method according to an embodiment of this disclosure. The method may be applied to the implementation environment shown in FIG. 1. In this embodiment of this disclosure, the method is described and executed by a second terminal. Referring to FIG. 9, the method may include the following steps.

In step 901, audio data is acquired by the second terminal.

The second terminal is any terminal participating in a target session, and the target session is a group session. During a session, the second terminal acquires audio data in real time through a microphone, and the audio data may include user voice data or audio data played by speakers of other terminals in a same space as the second terminal.

In step 902, watermark detection is performed by the second terminal on the audio data in response to the acquired audio data.

In a possible implementation, the step 902 described above may be implemented by a watermark parsing unit in the second terminal. FIG. 10 is a schematic diagram of a watermark parsing unit according to an embodiment of this disclosure. Referring to FIG. 10, the watermark parsing unit includes a watermark demodulation unit 1001, a channel decoding unit 1002, and a source decoding unit 1003. A watermark detection process is described below with reference to FIG. 10. One or more modules, submodules, and/or units of the apparatus can be implemented by processing circuitry, software, or a combination thereof, for example.

In Step 1, watermark demodulation is performed by the second terminal on audio data to obtain a watermark sequence.

In this embodiment of this disclosure, the second terminal first determines at least one watermark loading position in the audio data. For a watermark sequence loaded in a time domain, a cepstrum method may be used for analyzing the acquired audio data, so as to determine the watermark loading position. For example, the second terminal obtains a cepstrum of the audio data, and determines a position at which a peak value in the cepstrum is greater than a first threshold as the watermark loading position. For an audio watermark loaded in a transform domain, the second terminal performs DCT transformation on the audio data to obtain an energy intensity corresponding to each position of the audio data, and determines a position at which an energy intensity is greater than a second threshold as the watermark loading position. The first threshold and the second threshold may be set by a developer, which is not limited in this embodiment of this disclosure. The foregoing description of the method for determining a watermark loading position is only an exemplary description, and the method for determining a watermark loading position is not specifically limited in the embodiments of this disclosure.

In a possible implementation, the second terminal performs the watermark demodulation on the audio data based on the at least one watermark loading position, to obtain the watermark sequence, that is, extracts a hidden watermark sequence from the audio data. The method for performing watermark demodulation used by the second terminal is not specifically limited in the embodiments of this disclosure.

In Step 2, channel decoding and source decoding are performed by the second terminal on the watermark sequence to obtain a watermark text.

In a possible implementation, the second terminal performs channel decoding on a watermark sequence, that is, each channel-coded frame demodulated from the audio data. For example, the second terminal first performs cross-device bit alignment based on a synchronization code in a packet header of a channel-coded frame, and then corrects an error code generated during a channel transmission process based on an error correction code in a packet trailer of the channel-coded frame. In a case that the error correction is successful, the second terminal outputs decoded data to a source decoding unit. In a case that after the error correction, a quantity of error bits exceeds the error correction capability of the error correction code, that is, the error correction fails, the second terminal discards a data table and waits for decoding a next channel-coded frame.

In a possible implementation, the second terminal performs source decoding on a bit stream outputted by the channel decoding unit to obtain a watermark text. The watermark text includes a device identifier of a terminal participating in the target session, and certainly, also includes a session identifier of the target session and other information, which is not limited in this embodiment of this disclosure. For example, the second terminal performs source-side bit error check based on a check code in the bit stream. In a case that the check is passed, the second terminal performs content analysis on a data packet, that is, parses the content of a source data frame, to obtain a total byte length of the watermark text, a byte sequence number, and byte content of a current source data frame. In a case that the check fails, the second terminal discards the data packet and waits for decoding a next data packet.

In step 903, it is determined, by the second terminal in response to detection of an audio watermark in the audio data, that the second terminal and a terminal corresponding to the audio watermark are in a same physical space, and first prompt information is displayed on a session interface.

In a possible implementation, after extracting a watermark text from audio data, the second terminal compares a session identifier in the watermark text with a session identifier assigned by a server, and determines, in response to that two session identifiers are the same, that in acquired audio data, and among terminals participating in a target session, a terminal exists in a same space as the second terminal. Further, the second terminal determines, based on a device identifier in the watermark text, which terminal is in the same space as the second terminal.

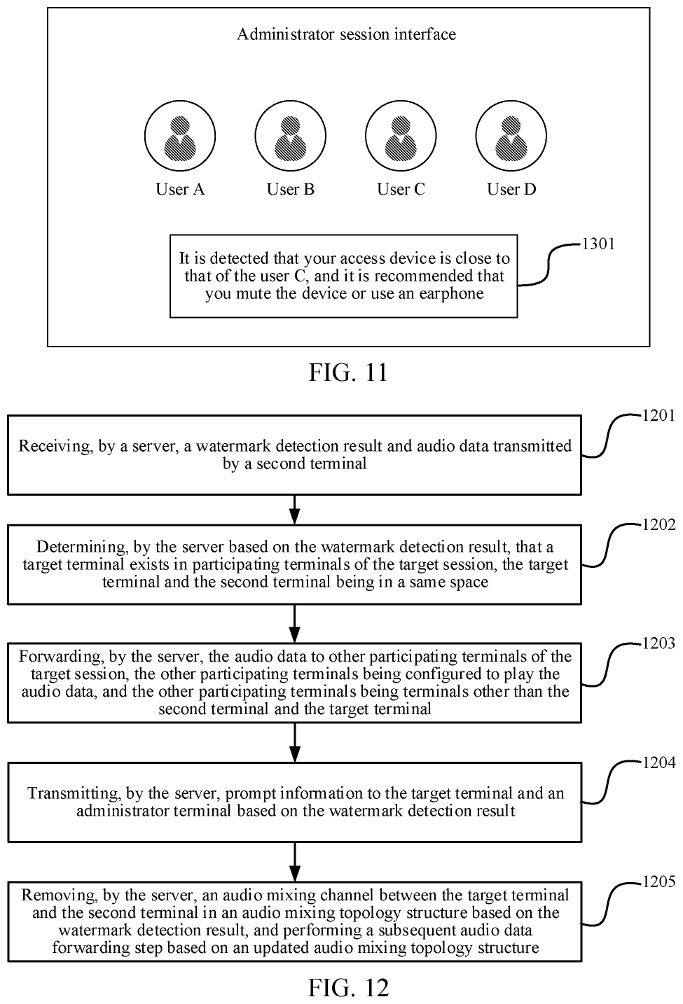

In a possible implementation, the second terminal may display first prompt information on a session interface of a target session based on a device identifier in a watermark text, and the first prompt information is used for instructing to disable a voice function of the second terminal, for example, prompting a user to mute the voice or to use an earphone to make a call. FIG. 11 is a schematic diagram of a session interface according to an embodiment of this disclosure. Referring to FIG. 11, there is first prompt information 1101 displayed on a session interface, so as to prompt a user to adjust voice function settings of a terminal. In this embodiment of this disclosure, in a case that a terminal exists in a same space as the second terminal, that is, in a case that the second terminal is in a state of a plurality of terminals in a same place, a UI prompt on a client interface may be triggered to inform the user which terminals are currently close, and prompt the user to check a microphone and a speaker.

In step 904, the audio data is processed by the second terminal based on a watermark detection result in response to detection of an audio watermark in the audio data, and the watermark detection result and the audio data after data processing are transmitted to a server, and the data is forwarded by the server.

The watermark detection result is used for indicating that a terminal participates in a same session as the second terminal and is in a same space as the second terminal. In a possible implementation, the watermark detection result includes a session identifier and a device identifier in the audio watermark, so as to inform the server which conference the second terminal is participating in and which terminal is in the same space as the second terminal.

In this embodiment of this disclosure, the second terminal may perform further data processing on acquired audio data based on the watermark detection result, that is, optimize the audio data to eliminate echo and howling in the audio data, and then transmit the optimized audio data and the watermark detection result to a server corresponding to the target session, and the server executes a subsequent data forwarding step.

In a possible implementation, the method for optimizing audio data by the second terminal includes any one of a plurality of implementations below.

In Implementation 1, attenuation processing is performed by the second terminal on an audio energy of the audio data based on the watermark detection result. For example, the second terminal determines, based on the watermark detection result, that a terminal exists in the same space as the second terminal, and may attenuate the audio data through an attenuator. The method for attenuation processing is not specifically limited in this embodiment of this disclosure. In this embodiment of this disclosure, by performing attenuation processing on an audio energy, the energy of the feedback sound of other terminals in the same space can be reduced, thereby preventing echo leakage and reducing the occurrence probability of howling.

In Implementation 2, echo cancellation is performed by the second terminal on the audio data based on the watermark detection result. For example, the second terminal is provided with an echo cancellation unit, and the second terminal determines, based on the watermark detection result, a terminal exists in the same space as the second terminal, and adjusts various parameters of the echo cancellation unit to enhance the intensity of post-processing filtering of the echo cancellation unit, thereby filtering out more echo in the audio data. The specific method for performing echo cancellation by the second terminal is not limited in this embodiment of this disclosure.

In Implementation 3, noise reduction is performed by the second terminal on the audio data based on the watermark detection result. For example, the second terminal is provided with a noise reduction unit, and after determining that an audio watermark exists in the audio data, the second terminal may determine, based on the watermark detection result, that a terminal exists in the same space as the second terminal, and the second terminal may enhance a noise reduction level of the noise reduction unit to remove more noise in the audio data.

In Implementation 4, muting processing is performed by the second terminal on the audio data based on the watermark detection result. For example, the second terminal determines, based on the watermark detection result, that a terminal exists in the same space as the second terminal, and may adjust an audio detection threshold in an audio acquisition stage. The audio detection threshold may be used for limiting the loudness, energy, and the like of the audio data, which is not limited in this embodiment of this disclosure, and the specific content of the audio detection threshold is set by a developer. In a possible implementation, the second terminal may adjust the audio detection threshold to larger data, and determine audio data whose audio energy, loudness, and the like are lower than the audio detection threshold as mute, so that audio data played by other terminals in the same space is more likely to be determined to be mute, and the audio data determined to be mute may not need to be transmitted to a server.

The foregoing description of the method for processing audio data is only an exemplary description of several possible implementations, and the method used for processing audio data is not specifically limited in the embodiments of this disclosure. In the embodiments of this disclosure, various implementations described above may be combined arbitrarily. For example, the second terminal may first perform echo cancellation on acquired audio data, and then perform attenuation processing, or may first perform noise reduction on audio data, and then perform attenuation processing. A combination manner used for processing audio data is not specifically limited in the embodiments of this disclosure.

In this embodiment of this disclosure, description is made in the order of performing the step 903 of displaying prompt information first, and then performing the step 904 of processing audio data. In some embodiments, the step of processing audio data may be performed first, and then the step of displaying prompt information may be performed, or both steps may be performed simultaneously. This is not limited in the embodiments of this disclosure.

In the technical solutions provided in the embodiments of this disclosure, a second terminal determines, by identifying an audio watermark in acquired audio data, that among terminals participating in a target session, a target terminal still exists in a same space as the second terminal, thereby prompting a user to disable a current voice function, so that an audio played by a speaker of the target terminal is prevented from being repeatedly acquired by a microphone of the second terminal, echo and howling are avoided during a session, and the session quality is improved.

A process of adding and parsing an audio watermark is mainly described in the foregoing embodiments. In this embodiment of this disclosure, after a second terminal transmits a watermark detection result and optimized audio data to a server, the server may forward the audio data based on the watermark detection result, and a terminal plays the forwarded audio data. FIG. 12 is a flowchart of forwarding and playing audio data according to an embodiment of this disclosure. Referring to FIG. 12, the method may include the following steps.

In step 1201, a watermark detection result and audio data transmitted by a second terminal are received by a server.

The second terminal is any terminal participating in a target session, and the target session is a group session.

In step 1202: it is determined, by the server based on the watermark detection result, that a target terminal (first terminal) exists in participating terminals of the target session (group communication session), the target terminal and the second terminal being in a same physical space.

In a possible implementation, the watermark detection result includes a session identifier and a device identifier, the session identifier refers to a target session that the second terminal participates in, and the device identifier refers to a terminal in the same space as the second terminal.

The server obtains the session identifier in the watermark detection result, determines, in response to that the session identifier is the same as a session identifier of a current target session, that a terminal exists in the same space as the second terminal in the participating terminals of the target session, and determines a specific terminal based on the device identifier in the watermark detection result. In this embodiment of this disclosure, an example in which the target terminal and the second terminal are in the same space is used for description.

In step 1203, the audio data is forwarded by the server to other participating terminals of the target session, the other participating terminals being configured to play the audio data, and the other participating terminals being terminals other than the second terminal and the target terminal.

In this embodiment of this disclosure, audio data acquired by a plurality of terminals in a same space is not forwarded among the plurality of terminals. That is, audio data acquired by the second terminal is not forwarded to the target terminal, and audio data acquired by the target terminal is not forwarded to the second terminal. The data forwarding mechanism can prevent a terminal from repeatedly playing a voice inputted by a user in a current space, and avoid generating echo and howling.

In step 1204, prompt information is transmitted by the server to the target terminal and an administrator terminal based on the watermark detection result.

In a possible implementation, the server transmits second prompt information to the target terminal. The second prompt information is used for indicating that the target terminal and the second terminal are in the same space, and may prompt a user using the target terminal to access an earphone to conduct a conversation. After the target terminal is connected to the earphone, the target terminal no longer plays audio data through a speaker, but plays the audio data through the earphone, and then the second terminal does not acquire the audio data played by the target terminal, thereby avoiding echo and howling in a group session.

In a possible implementation, the server transmits third prompt information to a third terminal. The third terminal is a management terminal of the target session, the third prompt information is used for indicating that the target terminal and the second terminal are in the same space, and a voice function of the target terminal or the second terminal needs to be disabled.

For example, the third prompt information includes a device identifier of the target terminal and a device identifier of the second terminal. An administrator user of the target session checks the third prompt information on the third terminal, and learns that the target terminal and the second terminal are in the same space. Then, the device identifier of the target terminal may be selected to disable the voice function of the target terminal, or the device identifier of the second terminal may be selected to disable the voice function of the second terminal. The administrator user may randomly determine to disable a voice function of which terminal, or the administrator user may select a terminal whose audio data is not currently acquired, and disable the voice function of the terminal.

In a possible implementation, the server transmits third prompt information to a third terminal. For example, after receiving watermark detection results transmitted by a plurality of terminals participating in a target session, the server summarizes the watermark detection results, generates the third prompt information, and transmits the third prompt information to an administrator user of the current target session. The third terminal is a management terminal of the target session, and the third prompt information is used for indicating that a terminal exists in a same space, and a voice function of at least one of at least two terminals in the same space needs to be disabled.

For example, the server may divide device identifiers of at least two terminals in the same space into one group by summarizing watermark detection results transmitted by a plurality of terminals, thereby obtaining at least one group of device identifiers, and generating third prompt information. The third prompt information includes at least one group of device identifiers, and the third prompt information is transmitted to the third terminal, and the administrator user of the target session checks the third prompt information on the third terminal to learn which terminals are in the same space, and may select a device identifier of a terminal whose voice function needs to be disabled from each group, thereby disabling the voice function of the corresponding terminal.

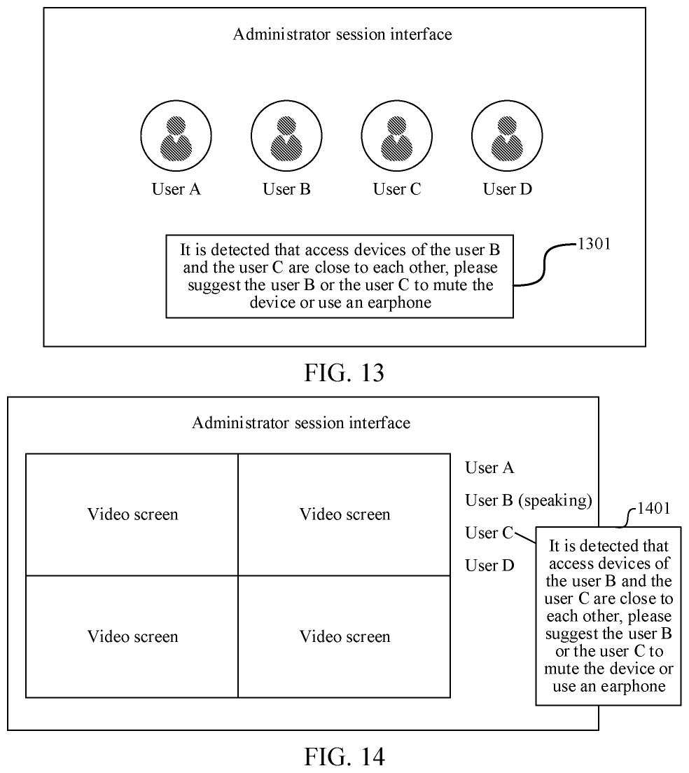

FIG. 13 is a schematic diagram of another session interface according to an embodiment of this disclosure. Referring to FIG. 13, the session interface is an administrator session interface, and third prompt information 1301 is displayed on the session interface. FIG. 14 is a schematic diagram of still another session interface according to an embodiment of this disclosure. Referring to FIG. 14, the session interface is an administrator session interface, and third prompt information 1401 is displayed on the session interface. The manner for displaying prompt information is not specifically limited in the embodiments of this disclosure.

In step 1205, an audio mixing channel between the target terminal and the second terminal is removed by the server in an audio mixing topology structure based on the watermark detection result, and a subsequent audio data forwarding step is performed based on an updated audio mixing topology structure.

In a possible implementation, an audio mixing topology structure is stored in the server, and the audio mixing topology structure includes audio mixing channels among terminals in the target session. After receiving audio data transmitted by any terminal, the server may mix audio based on the audio mixing topology structure, and then forward the audio data. In this embodiment of this disclosure, audio data acquired by a plurality of terminals in the same space does not need to be mixed. In a case that a terminal simultaneously receives the audio data acquired by the plurality of terminals in the same space, the server may select a channel of audio data with better quality to forward, that is, the audio data acquired by the target terminal and the second terminal is not forwarded at the same time to other terminals. The quality of audio may be determined based on factors such as a type of an audio acquisition device, an audio energy intensity, and a signal-to-noise ratio.

In a possible implementation, the server receives third audio data transmitted by a fourth terminal, the fourth terminal being a terminal in a different space from the target terminal and the second terminal in the target session. The server only needs to select one terminal from the target terminal and the second terminal for forwarding. For example, the server determines a data receiving terminal from the target terminal and the second terminal based on device types of the target terminal and the second terminal and in response to that speakers of the target terminal and the second terminal are in an on state; and forwards the third audio data to the data receiving terminal. For example, in a case that speakers of terminals are in an on state, the server may determine the data receiving terminal according to a priority of professional phone>notebook>mobile phone speaker>earphone. In a case that priorities of the terminals are the same, the server may prompt the user to specify the data receiving terminal, or the user may set a data receiving priority of terminals, which is not limited in this embodiment of this disclosure.

The step 1205 described above is an exemplary embodiment. In another embodiment of this disclosure, the audio mixing topology structure may not be stored, but other methods are used for recording whether the terminals in the target session are in the same space, and the audio data may be forwarded according to the record, so as to ensure that only one channel of audio data is forwarded among the audio data acquired by the plurality of terminals in the same space. For example, the server stores the device identifiers of the terminals in the same space in a same list, and stores device identifiers of terminals in different spaces in different lists, as long as it can distinguish which terminals are in the same space and which terminals are in different spaces.

An order of performing the step 1203, the step 1204, and the step 1205 described above is not specifically limited in this embodiment of this disclosure.

In the technical solutions provided in the embodiments of this disclosure, by transmitting a watermark detection result to a server, the server may obtain a location distribution of terminals participating in a target session during audio forwarding, so that selective audio data forwarding is performed based on the location distribution of the terminals, echo and howling in a session are eliminated from a data forwarding stage, and the session quality is improved.

In another embodiment of this disclosure, the step 1205 described above may also not be performed, but the audio data acquired by the terminals is forwarded, only the step 1204 described above is performed to prompt session users in a same space, and the session users actively use earphones or disable voice functions to reduce echo and howling.

In this embodiment of this disclosure, in a group session scenario, in a case that a phenomenon of a plurality of terminals in a same place is detected, according to one aspect, a user may be prompted to check a device by displaying prompt information on a session interface of the user, so as to prevent problems such as echo and howling that damage the voice; according to one aspect, in a case that acquired audio data includes sounds played by other terminals, the audio data is optimized, so as to eliminate the sounds of other devices and prevent echo leakage; and according to one aspect, a watermark detection result is transmitted to a server, and the server changes an audio mixing topology structure based on a terminal distribution indicated by the watermark detection result, selects channels for audio data uploaded by a plurality of terminals in a same space, selects a channel of audio data with the best quality and forwards the channel of audio data to other terminals, and removes an audio mixing channel of a plurality of terminals in a same place, so that the mixing and forwarding of repeated data are avoided, the repeated playing of audio data is avoided, and the session quality of a group session is improved.

By applying the technical solutions provided in the embodiments of this disclosure, cameras, projection devices, and screen sharing devices of terminals participating in a session can also be managed. For example, in a case of performing screen sharing, the solutions are applied to determine a plurality of terminals in a same space, and according to device types of the terminals, a shared video stream is transmitted to a selected device. For example, in a case that the plurality of terminals in the same space are respectively large-screen TVs and laptop computers, the user may be advised to share a video stream on the large-screen TVs to improve the video viewing experience and thus the session experience.

All the foregoing technical solutions may be combined to form an embodiment of this disclosure, and details are not described herein again.

The embodiments of this disclosure provide an application scenario in which a plurality of terminals are at a same location, that is, a scenario in which a plurality of terminals participating in a session access a same session at a same location (a same room, or a same location in a case that physical distances is relatively close). For example, a user A and a user B are in a same room, and a user C is located in another room, and the three participate in a target session through respective terminals. Therefore, the terminals of the user A, the user B, and the user C acquire audio data, transmit the audio data to a server, and the server forwards the audio data to other terminals, thereby implementing a session among the three. During the session, the following operations are also performed.

In operation 1, audio data X forwarded by the server is received by a terminal of the user A.

The audio data X may include a sound made by the user B, and may also include a sound made by the user C.

In operation 2, an audio watermark is added to the audio data X to obtain audio data Y, and then playing the audio data Y.

The terminal of the user A needs to play the received audio data for the user A to listen to. However, to facilitate subsequent identification of an identity of the terminal that plays the audio data, the terminal of the user A does not directly play the acquired audio data X, but first adds an audio watermark to the audio data X to obtain audio data Y. Because the audio watermark is determined based on a session identifier of a target session and a device identifier of the terminal of the user A, regardless of which device subsequently acquires the audio data Y, it may be determined through the audio watermark that the audio data Y is transmitted by the terminal of the user A in the target session.

In operation 3, audio data is acquired by a terminal of the user B, where audio data Z is acquired.

Because the user A and the user B are in the same room, and the user A plays the audio data Y, the terminal of the user B acquires the audio data Y during audio data acquisition. That is, the audio data Z includes the audio data Y, and thus includes the audio watermark added to the audio data Y. In addition, because the audio data Y itself is acquired by another terminal other than the terminal of the user A, it may be the sound made by the user B or the sound made by the user C. In this case, if the user B transmits the acquired audio data Z to the server, and then the server forwards the audio data Z to other terminals, echo or howling is likely to occur.

In operation 4, it is determined, by the terminal of the user B in response to detecting that an audio watermark exists in the audio data Z, that the second terminal and a terminal corresponding to the audio watermark (the terminal of the user A) are in a same space; and first prompt information is displayed, the first prompt information being used for instructing the user B to disable a voice function of the terminal or to access an earphone.

In this case, if the user B disables the voice function and mutes the voice according to the first prompt information, the acquired audio data is not forwarded subsequently, thus avoiding the occurrence of echo or howling. Alternatively, if the user B accesses the earphone according to the first prompt information, only the sound made by the user B can be acquired, and the sound made by the user A is no longer acquired, which can also avoid echo or howling.

In operation 5, the audio data Z is processed by the terminal of the user B based on a watermark detection result; and the watermark detection result and the processed audio data are transmitted to the server.

In operation 6, the watermark detection result and the audio data transmitted by the terminal of the user B are received by the server; it is determined, based on the watermark detection result, that the user A and the user B are in the same space. The user A can already hear the sound of the user B without the need of the forwarding by the server. Therefore, the server forwards the audio data to another participating terminal of the target session, that is, the terminal of the user C, instead of the terminal of the user A, thereby not only ensuring a smooth session between participating parties, but also avoiding echo and howling.

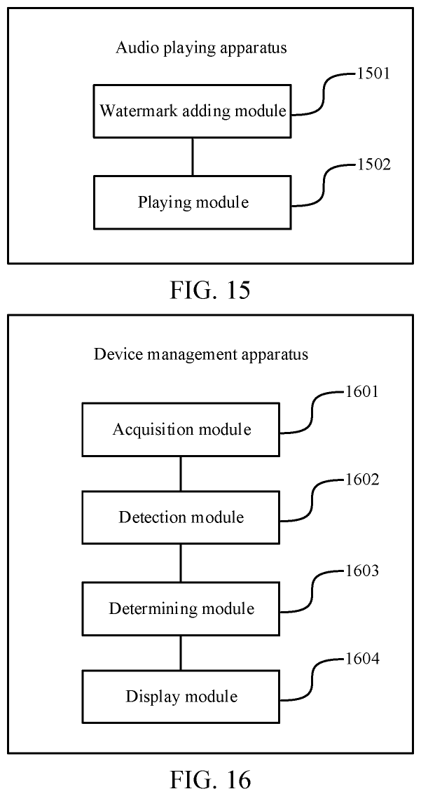

FIG. 15 is a schematic structural diagram of an audio playing apparatus according to an embodiment of this disclosure. Referring to FIG. 15, the apparatus is located at a first terminal, the first terminal is a terminal participating in a target session, and the apparatus includes: a watermark adding module 1501, configured to obtain to-be-played first audio data, and add an audio watermark to the first audio data to obtain second audio data, the audio watermark being determined based on a session identifier of the target session and a device identifier of the first terminal; and a playing module 1502, configured to play the second audio data.

In a possible implementation, the watermark adding module 1501 includes: an obtaining unit, configured to obtain a watermark text based on the session identifier of the target session and the device identifier of the first terminal; an encoding unit, configured to perform source coding and channel coding on the watermark text to obtain a watermark sequence; and a loading unit, configured to load the watermark sequence into the first audio data to obtain the second audio data.

In a possible implementation, the loading unit includes: a position determination subunit, configured to determine at least one watermark loading position in the first audio data based on an energy spectrum envelope of the first audio data; and a loading subunit, configured to load the watermark sequence at the at least one watermark loading position to obtain the second audio data.

In a possible implementation, the position determination subunit is configured to: compare the energy spectrum envelope of the first audio data with a reference threshold; and determine a position corresponding to an energy spectrum envelope greater than the reference threshold in the first audio data as the at least one watermark loading position.

In the apparatus provided in this embodiments of this disclosure, an audio watermark is added to to-be-played audio data during a session. Because the audio watermark is associated with a device identifier of a terminal, the audio watermark can be used for indicating which terminal the audio data is played by. That is, it may be determined according to the audio watermark that a terminal that acquires the audio data and the terminal that plays the audio data are in a same space, which is convenient for users to perform subsequent device management.

In a case that the audio playing apparatus provided in the foregoing embodiment plays an audio, classification of the foregoing functional modules is merely used as an example for description. In actual applications, the foregoing functions may be allocated to different functional modules for implementation according to requirements. That is, an internal structure of the apparatus is divided into different functional modules, to implement all or some of the functions described above. In addition, the audio playing apparatus provided in the foregoing embodiment belongs to the same conception as the embodiments of the audio playing method. For details of a specific implementation process, refer to the method embodiments. Details are not described herein again.

FIG. 16 is a schematic structural diagram of a device management apparatus according to an embodiment of this disclosure. Referring to FIG. 16, the apparatus is located at a second terminal, and the apparatus includes: an acquisition module 1601, configured to acquire audio data, the second terminal being a terminal participating in a target session; a detection module 1602, configured to perform watermark detection on the audio data in response to the acquired audio data; a determining module 1603, configured to determine, in response to detecting that an audio watermark exists in the audio data, that the second terminal and a terminal corresponding to the audio watermark are in a same space; and a display module 1604, configured to display first prompt information, the first prompt information being used for instructing to disable a voice function of the second terminal.

In a possible implementation, the detection module 1602 includes: a demodulation unit, configured to perform watermark demodulation on the audio data to obtain a watermark sequence; and a decoding unit, configured to perform channel decoding and source decoding on the watermark sequence to obtain a watermark text, where the watermark text includes a device identifier of the terminal participating in the target session.

In a possible implementation, the demodulation unit includes: a position determining subunit, configured to determine at least one watermark loading position in the audio data; and a demodulation subunit, configured to perform the watermark demodulation on the audio data based on the at least one watermark loading position, to obtain the watermark sequence.

In a possible implementation, the position determining subunit is configured to perform any one of the following: obtain a cepstrum of the audio data, and determine a position at which a peak value in the cepstrum is greater than a first threshold as the watermark loading position; or perform discrete cosine transform on the audio data to obtain an energy intensity corresponding to each position of the audio data, and determine a position at which an energy intensity is greater than a second threshold as the watermark loading position.

In a possible implementation, the apparatus further includes: a data processing module, configured to perform data processing on the audio data based on a watermark detection result; and a transmitting module, configured to transmit the watermark detection result and the processed audio data to a server, where the server is configured to forward the processed audio data based on the watermark detection result.

In a possible implementation, the data processing module is configured to perform any one of the following: perform attenuation processing on an audio energy of the audio data; perform echo cancellation on the audio data based on the watermark detection result; perform noise reduction on the audio data based on the watermark detection result; or perform muting processing on the audio data.

In the apparatus provided in this embodiment of this disclosure, a second terminal determines, by identifying an audio watermark in acquired audio data, that among terminals participating in a target session, a target terminal still exists in a same space as the second terminal, thereby prompting a user to disable a current voice function, so that an audio played by a speaker of the target terminal is prevented from being repeatedly acquired by a microphone of the second terminal, echo and howling are avoided during a session, and the session quality is improved.

In a case that the device management apparatus provided in the foregoing embodiment performs device management, classification of the foregoing functional modules is merely used as an example for description. In actual applications, the foregoing functions may be allocated to different functional modules for implementation according to requirements. That is, an internal structure of the apparatus is divided into different functional modules, to implement all or some of the functions described above. In addition, the device management apparatus provided in the foregoing embodiments and the embodiments of the device management method belong to a same concept. For a specific implementation process, refer to the method embodiments, and details are not described herein again.

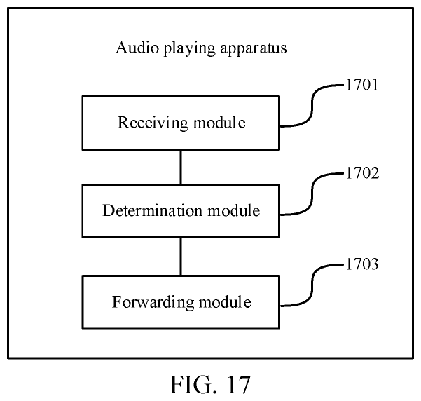

FIG. 17 is a schematic structural diagram of an audio playing apparatus according to an embodiment of this disclosure. Referring to FIG. 17, the apparatus includes: a receiving module 1701, configured to receive a watermark detection result and audio data transmitted by a second terminal, the second terminal being a terminal participating in a target session; a determination module 1702, configured to determine, based on the watermark detection result, that a target terminal exists in participating terminals of the target session, the target terminal and the second terminal being in a same space; and a forwarding module 1703, configured to forward the audio data to other participating terminals of the target session, the other participating terminals being configured to play the audio data, and the other participating terminals being terminals other than the second terminal and the target terminal.

In a possible implementation, the apparatus further includes a sending module, configured to: transmit second prompt information to the target terminal, where the second prompt information is used for indicating that the target terminal and the second terminal are in the same space; and transmit third prompt information to a third terminal, where the third terminal is a management terminal of the target session, the third prompt information is used for indicating that the target terminal and the second terminal are in the same space, and a voice function of the target terminal or the second terminal needs to be disabled.

In a possible implementation, the apparatus further includes a removing module, configured to: remove an audio mixing channel between the target terminal and the second terminal in an audio mixing topology structure based on the watermark detection result, the audio mixing topology structure including audio mixing channels among terminals in the target session.

In a possible implementation, the receiving module 1701 is configured to receive third audio data transmitted by a fourth terminal, the fourth terminal being a terminal in a different space from the target terminal and the second terminal in the target session;

the determination module 1702 is configured to determine a data receiving terminal from the target terminal and the second terminal based on device types of the target terminal and the second terminal and in response to that speakers of the target terminal and the second terminal are in an on state; and

the forwarding module 1703 is configured to forward the third audio data to the data receiving terminal.

In the apparatus provided in this embodiment of this disclosure, by transmitting a watermark detection result to a server, the server may obtain a location distribution of terminals participating in a target session during audio forwarding, so that selective audio data forwarding is performed based on the location distribution of the terminals, echo and howling in a session are eliminated from a data forwarding stage, and the session quality is improved.

In a case that the audio playing apparatus provided in the foregoing embodiment plays an audio, classification of the foregoing functional modules is merely used as an example for description. In actual applications, the foregoing functions may be allocated to different functional modules for implementation according to requirements. That is, an internal structure of the apparatus is divided into different functional modules, to implement all or some of the functions described above. In addition, the audio playing apparatus provided in the foregoing embodiment belongs to the same conception as the embodiments of the audio playing method. For details of a specific implementation process, refer to the method embodiments. Details are not described herein again.

An embodiment of this disclosure further provides a computer device, including one or more processors (including processing circuitry) and one or more memories (including a non-transitory computer-readable storage medium), the one or more memories storing at least one piece of program code, the at least one piece of program code being loaded and executed by the one or more processors to implement operations in the foregoing embodiments.

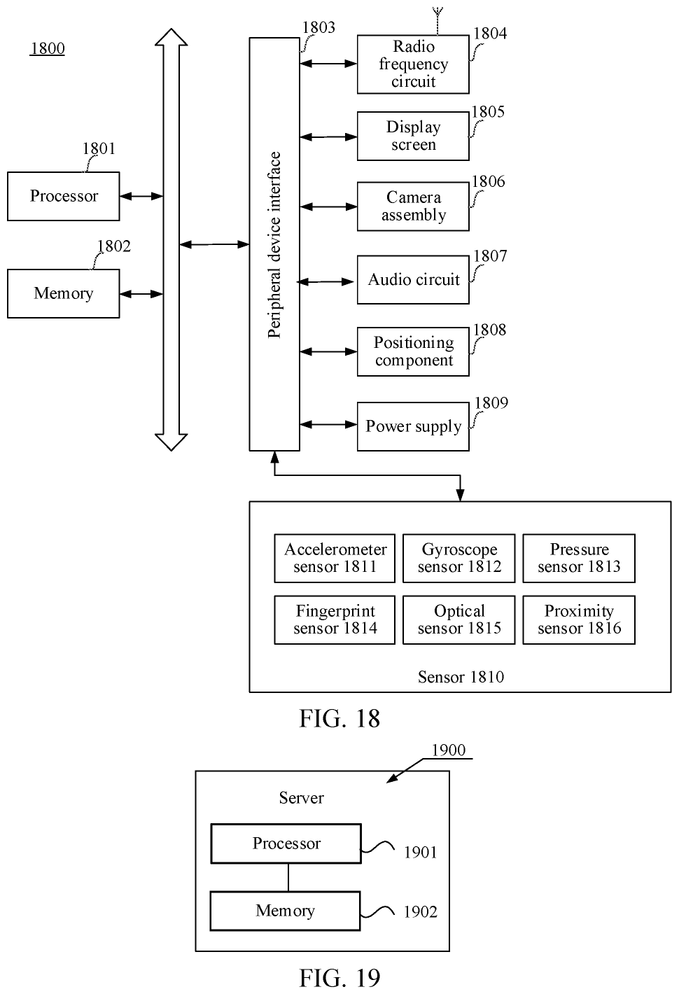

The computer device provided in the foregoing technical solutions may be implemented as a terminal or a server. For example, FIG. 18 is a schematic structural diagram of a terminal according to an embodiment of this disclosure. The terminal 1800 may be: a smart phone, a tablet computer, a Moving Picture Experts Group Audio Layer III (MP3) player, a Moving Picture Experts Group Audio Layer IV (MP4) player, a notebook computer, or a desktop computer. The terminal 1800 may also be referred to other names such as user equipment, a portable terminal, a laptop terminal, or a desktop terminal.

Generally, the terminal 1800 includes one or more processors 1801 and one or more memories 1802.

The processor 1801 may include one or more processing cores, such as a 4-core processor or an 8-core processor. The processor 1801 may be implemented by at least one hardware form in a digital signal processing (DSP), a field-programmable gate array (FPGA), and a programmable logic array (PLA). The processor 1801 may also include a main processor and a coprocessor. The main processor is a processor for processing data in a wake-up state, also referred to as a central processing unit (CPU). The coprocessor is a low power consumption processor configured to process data in a standby state. In some embodiments, the processor 1801 may be integrated with a graphic processing unit (GPU). The GPU is configured to render and plot what needs to be displayed on a display screen. In some embodiments, the processor 1801 may further include an artificial intelligence (AI) processor. The AI processor is configured to process a computing operation related to machine learning.

The memory 1802 may include one or more computer-readable storage media. The computer-readable storage media may be non-transitory. The memory 1802 may also include a high-speed random access memory, as well as non-volatile memory, such as one or more disk storage devices and flash storage devices. In some embodiments, a non-transitory computer-readable storage medium in the memory 1802 is configured to store at least one piece of program code, the at least one piece of program code being configured to be executed by the processor 1801 to implement the audio playing method or the device management method provided in the method embodiments of this disclosure.

In some embodiments, the terminal 1800 may further include: a peripheral device interface 1803 and at least one peripheral device. The processor 1801, the memory 1802, and the peripheral interface 1803 may be connected by a bus or a signal line. Each peripheral device may be connected to the peripheral device interface 1803 by using a bus, a signal line, or a circuit board. Specifically, the peripheral device includes: at least one of a radio frequency circuit 1804, a display screen 1805, a camera assembly 1806, an audio circuit 1807, a positioning component 1808, and a power supply 1809.

The peripheral device interface 1803 may be configured to connect at least one peripheral device related to input/output (I/O) to the processor 1801 and the memory 1802. In some embodiments, the processor 1801, the memory 1802, and the peripheral device interface 1803 are integrated on the same chip or the same circuit board. In some other embodiments, any one or two of the processor 1801, the memory 1802, and the peripheral device interface 1803 may be implemented on a separate chip or circuit board, which is not limited in this embodiment.

The radio frequency circuit 1804 is configured to receive and transmit a radio frequency (RF) signal, which is also referred to as an electromagnetic signal. The radio frequency circuit 1804 communicates with a communication network and other communication devices through the electromagnetic signal. The radio frequency circuit 1804 converts an electrical signal into an electromagnetic signal for transmission, or converts a received electromagnetic signal into an electrical signal. The radio frequency circuit 1804 includes: an antenna system, an RF transceiver, one or more amplifiers, a tuner, an oscillator, a digital signal processor, a codec chip set, a subscriber identity module card, and the like. The radio frequency circuit 1804 may communicate with other terminals through at least one wireless communication protocol. The wireless communication protocol includes, but is not limited to, a metropolitan area network, different generations of mobile communication networks (2G, 3G, 4G, and 5G), a wireless local area network, and/or a Wi-Fi network. In some embodiments, the radio frequency circuit 1804 may also include a circuit related to near field communication (NFC), which is not limited in this disclosure.

The display screen 1805 is configured to display a user interface (UI). The UI may include a graph, a text, an icon, a video, and any combination thereof. When the display screen 1805 is a touch display screen, the display screen 1805 also has the ability to acquire a touch signal at or above the surface of the display screen 1805. The touch signal may be inputted, as a control signal, to the processor 1801 for processing. In this case, the display screen 1805 may also be configured to provide virtual buttons and/or virtual keyboards, also referred to as soft buttons and/or soft keyboards. In some embodiments, there may be one display screen 1805 disposed on a front panel of the terminal 1800. In some other embodiments, there may be two display screens 1805 respectively arranged on different surfaces of the terminal 1800 or in a folded design. In some embodiments, the display screen 1805 may be a flexible display screen arranged on a curved or folded surface of the terminal 1800. Even further, the display screen 1805 may be arranged in a non-rectangular irregular pattern, that is, a special-shaped screen. The display screen 1805 may be made of materials such as liquid crystal display (LCD) and organic light-emitting diode (OLED).

The camera assembly 1806 is configured to capture images or videos. The camera assembly 1806 includes a front-facing camera and a rear-facing camera. Generally, the front-facing camera is arranged on a front panel of the terminal, and the rear-facing camera is arranged on a rear surface of the terminal. In some embodiments, there are at least two rear-facing cameras, each being any one of a main camera, a depth-of-field camera, a wide-angle camera, and a telephoto camera, to achieve a background blurring function through fusion of the main camera and the depth-of-field camera, panoramic photo shooting and virtual reality (VR) shooting functions through fusion of the main camera and the wide-angle camera, or another fusion shooting function. In some embodiments, the camera assembly 1806 may further include a flash. The flash may be a single color temperature flash or a double color temperature flash. The double color temperature flash refers to a combination of a warm light flash and a cold light flash, and may be used for light compensation under different color temperatures.

The audio circuit 1807 may include a microphone and a speaker. The microphone is configured to acquire sound waves from a user and an environment and convert the sound waves into electrical signals that are inputted to the processor 1801 for processing or to the radio frequency circuit 1804 for voice communication. For purposes of stereo acquisition or noise reduction, there may be a plurality of microphones, which are respectively arranged at different parts of the terminal 1800. The microphone may be alternatively a microphone array or an omnidirectional acquisition microphone. The speaker is configured to convert the electrical signals from the processor 1801 or the radio frequency circuit 1804 into sound waves. The speaker may be a conventional thin-film speaker or a piezoelectric ceramic speaker. When the speaker is the piezoelectric ceramic speaker, the speaker can not only convert an electric signal into sound waves audible to a human being, but also convert an electric signal into sound waves inaudible to the human being for ranging and other purposes. In some embodiments, the audio circuit 1807 may further include an earphone jack.

The positioning component 1808 is configured to position a current geographic location of the terminal 1800 to implement navigation or location based service (LBS). The positioning component 1808 may be a positioning component based on a global positioning system (GPS) of the United States, a Beidou system of China, a Glonass system of Russia, or a Galileo system of the European Union.

The power supply 1809 is configured to supply power to components in the terminal 1800. The power supply 1809 may be an alternating current, a direct current, a disposable battery, or a rechargeable battery. When the power supply 1809 includes a rechargeable battery, the rechargeable battery may support either wired charging or wireless charging. The rechargeable battery may also be configured to support fast charge technology.

In some embodiments, the terminal 1800 further includes one or more sensors 1810. The one or more sensors 1810 include, but are not limited to: an acceleration sensor 1811, a gyroscope sensor 1812, a pressure sensor 1813, a fingerprint sensor 1814, an optical sensor 1815, and a proximity sensor 1816.

The acceleration sensor 1811 may detect the magnitude of acceleration on three coordinate axes of a coordinate system established with the terminal 1800. For example, the acceleration sensor 1811 may be configured to detect the components of gravitational acceleration on three coordinate axes. The processor 1801 may control the display screen 1805 to display the UI in a lateral view or a longitudinal view according to a gravitational acceleration signal acquired by the acceleration sensor 1811. The acceleration sensor 1811 may also be configured to acquire game or user motion data.

The gyroscope sensor 1812 may detect a body direction and a rotation angle of the terminal 1800, and the gyroscope sensor 1812 may acquire a 3D motion of the terminal 1800 by a user in cooperation with the acceleration sensor 1811. The processor 1801 may implement the following functions according to the data acquired by the gyroscope sensor 1812: motion sensing (such as changing the UI according to a tilting operation of the user), image stabilization at the time of photographing, game control, and inertial navigation.

The pressure sensor 1813 may be arranged on a side frame of the terminal 1800 and/or a lower layer of the display screen 1805. When the pressure sensor 1813 is arranged on the side frame of the terminal 1800, a grip signal of the user to the terminal 1800 may be detected, and the processor 1801 performs left and right hand recognition or a quick operation according to the grip signal acquired by the pressure sensor 1813. When the pressure sensor 1813 is arranged on the lower layer of the display screen 1805, the processor 1801 controls an operable control on the UI interface according to a pressure operation of the user on the display screen 1805. The operable control includes at least one of a button control, a scroll-bar control, an icon control, and a menu control.

The fingerprint sensor 1814 is configured to acquire a fingerprint of the user, and an identity of the user is recognized by the processor 1801 according to the fingerprint acquired by the fingerprint sensor 1814, or the identity of the user is recognized by the fingerprint sensor 1814 according to the acquired fingerprint. Upon recognizing the identity of the user as a trusted identity, the user is authorized by the processor 1801 to perform related sensitive operations including unlocking the screen, viewing encrypted information, downloading software, paying for and changing settings, and the like. The fingerprint sensor 1814 may be arranged on the front, back, or side of the terminal 1800. When a physical key or vendor logo is arranged on the terminal 1800, the fingerprint sensor 1814 may be integrated with the physical key or the vendor logo.

The optical sensor 1815 is configured to collect ambient light intensity. In one embodiment, the processor 1801 may control the display brightness of the display screen 1805 according to the ambient light intensity acquired by the optical sensor 1815. Specifically, when the ambient light intensity is high, the display brightness of the display screen 1805 is increased; and when the ambient light intensity is low, the display brightness of the display screen 1805 is decreased. In another embodiment, the processor 1801 may also dynamically adjust camera parameters of the camera assembly 1806 according to the ambient light intensity acquired by the optical sensor 1815.

The proximity sensor 1816, also referred to as a distance sensor, is typically arranged on the front panel of the terminal 1800. The proximity sensor 1816 is configured to collect a distance between the user and a front surface of the terminal 1800. In one embodiment, when the proximity sensor 1816 detects that the distance between the user and the front surface of the terminal 1800 is gradually reduced, the processor 1801 controls the display screen 1805 to switch from a screen-on state to a screen-off state. When the proximity sensor 1816 detects that the distance between the user and the front surface of the terminal 1800 is gradually increased, the processor 1801 controls the display screen 1805 to switch from a screen-off state to a screen-on state.

A person skilled in the art may understand that the structure shown in FIG. 18 does not constitute a limitation to the terminal 1800, and the terminal may include more components or fewer components than those shown in the figure, or some components may be combined, or a different component deployment may be used.

The terminal described above may be implemented as the first terminal shown in the foregoing method embodiments, the first terminal is a terminal participating in a target session, and at least one piece of program code stored in the memory 1802 is loaded and executed by one or more processors 1801 to implement the following operations: obtaining to-be-played first audio data; adding an audio watermark to the first audio data to obtain second audio data, the audio watermark being determined based on a session identifier of the target session and a device identifier of the first terminal; and playing the second audio data.

In a possible implementation, the at least one piece of program code is loaded and executed by the one or more processors 1801 to implement the following operations: obtaining a watermark text based on the session identifier of the target session and the device identifier of the first terminal; performing source coding and channel coding on the watermark text to obtain a watermark sequence; and loading the watermark sequence into the first audio data to obtain the second audio data.

In a possible implementation, the at least one piece of program code is loaded and executed by the one or more processors 1801 to implement the following operations: determining at least one watermark loading position in the first audio data based on an energy spectrum envelope of the first audio data; and loading the watermark sequence at the at least one watermark loading position to obtain the second audio data.

In a possible implementation, the at least one piece of program code is loaded and executed by the one or more processors 1801 to implement the following operations: comparing the energy spectrum envelope of the first audio data with a reference threshold; and determining a position corresponding to an energy spectrum envelope greater than the reference threshold in the first audio data as the at least one watermark loading position.

The terminal described above may be implemented as the second terminal shown in the foregoing method embodiments, the second terminal is a terminal participating in a target session, and at least one piece of program code stored in the memory 1802 is loaded and executed by one or more processors 1801 to implement the following operations: acquiring audio data;

performing watermark detection on the audio data in response to the acquired audio data; determining, in response to detecting that an audio watermark exists in the audio data, that the second terminal and a terminal corresponding to the audio watermark are in a same space; and displaying first prompt information, the first prompt information being used for instructing to disable a voice function of the second terminal.

The performing watermark detection on the audio data in response to the acquired audio data includes: performing watermark demodulation on the audio data to obtain a watermark sequence; and performing channel decoding and source decoding on the watermark sequence to obtain a watermark text, where the watermark text includes a device identifier of a terminal that plays the audio data.

In a possible implementation, the at least one piece of program code is loaded and executed by the one or more processors 1801 to implement the following operations: determining at least one watermark loading position in the audio data; and performing the watermark demodulation on the audio data based on the at least one watermark loading position, to obtain the watermark sequence.

In a possible implementation, the at least one piece of program code is loaded and executed by the one or more processors 1801 to implement the following operations: processing the audio data based on a watermark detection result; and transmitting the watermark detection result and the processed audio data to a server, where the server is configured to forward the processed audio data based on the watermark detection result.

In a possible implementation, the at least one piece of program code is loaded and executed by the one or more processors 1801 to implement the following operations: performing attenuation processing on an audio energy of the audio data based on the watermark detection result; performing echo cancellation on the audio data based on the watermark detection result;

performing noise reduction on the audio data based on the watermark detection result; or performing muting processing on the audio data based on the watermark detection result.

In a possible implementation, the at least one piece of program code is loaded and executed by the one or more processors 1801 to implement the following operations: obtaining a cepstrum of the audio data, and determining a position at which a peak value in the cepstrum is greater than a first threshold as the watermark loading position; or performing discrete cosine transform on the audio data to obtain an energy intensity corresponding to each position of the audio data, and determining a position at which an energy intensity is greater than a second threshold as the watermark loading position.

FIG. 19 is a schematic structural diagram of a server according to an embodiment of this disclosure. The server 1900 may vary greatly because a configuration or performance varies, and may include one or more central processing units (CPU) 1901 and one or more memories 1902. The one or more memories 1902 store at least one piece of program code, and the at least one piece of program code is loaded and executed by the one or more processors 1901 to implement the methods provided in the foregoing various method embodiments. Certainly, the server 1900 may also have a wired or wireless network interface, a keyboard, an input/output interface and other components to facilitate input/output. The server 1900 may also include other components for implementing device functions. Details are not described herein again.

The server described above may be implemented as the server shown in the foregoing method embodiments, and at least one piece of program code stored in the memory 1902 is loaded and executed by one or more processors 1901 to implement the following operations: receiving a watermark detection result and audio data transmitted by a second terminal, the second terminal being a terminal participating in a target session; determining, based on the watermark detection result, that a target terminal exists in participating terminals of the target session, the target terminal and the second terminal being in a same space; and forwarding the audio data to other participating terminals of the target session, the other participating terminals being configured to play the audio data, and the other participating terminals being terminals other than the second terminal and the target terminal.

In a possible implementation, the at least one piece of program code is loaded and executed by the one or more processors 1901 to implement the following operations: transmitting second prompt information to the target terminal, where the second prompt information is used for indicating that the target terminal and the second terminal are in the same space; and transmitting third prompt information to a third terminal, where the third terminal is a management terminal of the target session, the third prompt information is used for indicating that the target terminal and the second terminal are in the same space, and a voice function of the target terminal or the second terminal needs to be disabled.

In a possible implementation, the at least one piece of program code is loaded and executed by the one or more processors 1901 to implement the following operations: removing an audio mixing channel between the target terminal and the second terminal in an audio mixing topology structure based on the watermark detection result, the audio mixing topology structure including audio mixing channels among terminals in the target session.

In a possible implementation, the at least one piece of program code is loaded and executed by the one or more processors 1901 to implement the following operations: receiving third audio data transmitted by a fourth terminal, the fourth terminal being a terminal in a different space from the target terminal and the second terminal in the target session; determining a data receiving terminal from the target terminal and the second terminal based on device types of the target terminal and the second terminal and in response to that speakers of the target terminal and the second terminal are in an on state; and forwarding the third audio data to the data receiving terminal.

In an exemplary embodiment, a computer-readable storage medium, for example, a memory including at least one piece of program code is further provided. The at least one piece of program code may be executed by a processor to implement the audio playing method or the device management method in the foregoing embodiments. For example, the computer-readable storage medium may be a read-only memory (ROM), a random access memory (RAM), a compact disc ROM (CD-ROM), a magnetic tape, a floppy disk, an optical data storage device, or the like.

In an exemplary embodiment, a computer program product is further provided, including at least one piece of program code, the at least one piece of program code being stored in a computer-readable storage medium. A processor of a computer device reads the at least one piece of program code from the computer-readable storage medium, and the processor executes the at least one piece of program code, to cause the computer device to implement operations performed in the audio playing method or the device management method.

A person of ordinary skill in the art may understand that all or some of the steps of the foregoing embodiments may be implemented by hardware, or may be implemented by a program instructing hardware related to at least one piece of program code. The program may be stored in a computer-readable storage medium. The storage medium may be: a ROM, a magnetic disk, or an optical disc.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. An audio playing method, performed by a first terminal participating in a group communication session, the method comprising:
obtaining first audio data of the group communication session;
adding an audio watermark to the first audio data to obtain second audio data, the audio watermark including on a session identifier of the group communication session and a device identifier of the first terminal; and
playing the second audio data.

2. The method according to claim 1, wherein the adding the audio watermark to the first audio data to obtain the second audio data comprises:
obtaining a watermark text based on the session identifier of the group communication session and the device identifier of the first terminal;
performing source coding and channel coding on the watermark text to obtain a watermark sequence; and
loading the watermark sequence into the first audio data to obtain the second audio data.

3. The method according to claim 2, wherein the loading the watermark sequence into the first audio data to obtain the second audio data comprises:
determining at least one watermark loading position in the first audio data based on an energy spectrum envelope of the first audio data; and
loading the watermark sequence at the at least one watermark loading position to obtain the second audio data.

4. The method according to claim 3, wherein the determining the at least one watermark loading position comprises:
comparing the energy spectrum envelope of the first audio data with a reference threshold; and
determining a position corresponding to an energy spectrum envelope greater than the reference threshold in the first audio data as the at least one watermark loading position.

5. The method according to claim 1, further comprising:
receiving a notification of a determination that the first terminal is located in a same physical space as a second terminal participating in the group communication session,
wherein the determination that the first terminal is located in the same physical space as the second terminal is based on detection of the audio watermark within audio data captured by the second terminal.

6. The method according to claim 5, further comprising:
based on the determination that the first terminal is located in the same physical space as the second terminal, displaying prompt information instructing to disable a voice function of the first terminal.

7. A device management method, performed by a second terminal, the method comprising:
acquiring, by the second terminal, audio data, the second terminal being a terminal participating in a group communication session;
performing watermark detection on the acquired audio data;
determining, in response to detection of an audio watermark in the acquired audio data, that the second terminal and another terminal identified by the detected audio watermark are in a same physical space; and
displaying first prompt information, the first prompt information instructing to disable a voice function of the second terminal.

8. The method according to claim 7, wherein the performing the watermark detection comprises:
performing watermark demodulation on the acquired audio data to obtain a watermark sequence; and
performing channel decoding and source decoding on the watermark sequence to obtain a watermark text, wherein the watermark text comprises a device identifier of the another terminal, which plays the audio data.

9. The method according to claim 8, wherein the performing the watermark demodulation comprises:
determining at least one watermark loading position in the acquired audio data; and
performing the watermark demodulation on the acquired audio data based on the at least one watermark loading position, to obtain the watermark sequence.

10. The method according to claim 7, wherein, after the determining that the second terminal and the another terminal are in the same physical space, the method further comprises:
processing the acquired audio data based on a watermark detection result; and
transmitting the watermark detection result and the processed audio data to a server, wherein the server is configured to forward the processed audio data based on the watermark detection result to other terminals participating in the group communication session.

11. The method according to claim 10, wherein the processing the acquired audio data comprises one or more of:
performing attenuation processing on an audio energy of the acquired audio data based on the watermark detection result;
performing echo cancellation on the acquired audio data based on the watermark detection result;
performing noise reduction on the acquired audio data based on the watermark detection result; or
performing muting processing on the acquired audio data based on the watermark detection result.

12. The method according to claim 7, wherein the another terminal is a participant in the group communication session and the acquired audio data is audio data of the group communication session output by the another terminal.

13. An audio playing method, performed by a server, the method comprising:
receiving a watermark detection result and audio data acquired by a second terminal, the second terminal being a terminal participating in a group communication session;
determining, based on the watermark detection result, that a first terminal among participating terminals of the group communication session is in a same physical space as the second terminal; and
forwarding the audio data to other participating terminals of the group communication session, the other participating terminals being configured to play the audio data, and the other participating terminals being terminals other than the second terminal and the first terminal.

14. The method according to claim 13, wherein, after the determining, the method further comprises:
transmitting second prompt information to the first terminal, wherein the second prompt information indicates that the first terminal and the second terminal are in the same physical space; and
transmitting third prompt information to a third terminal, wherein the third terminal is a management terminal of the group communication session, the third prompt information indicating that the first terminal and the second terminal are in the same physical space, and a voice function of the first terminal or the second terminal needs to be disabled.

15. The method according to claim 14, wherein the second prompt information prompts a user of the first terminal to participate in the group communication session via headphones.

16. The method according to claim 14, wherein the third prompt information allows the management terminal to disable a voice function of at least one of the first terminal or the second terminal.

17. The method according to claim 13, wherein the watermark detection result includes a session identifier and a device identifier, the session identifier identifies the group communication session, and the device identifier identifies the first terminal in the same physical space as the second terminal.

18. The method according to claim 17, wherein the determining that a first terminal among participating terminals of the group communication session is in a same physical space as the second terminal comprises determining that the session identifier in the watermark detection result is the same as a session identifier of a current group communication session.

19. The method according to claim 17, wherein the method further comprises determining the first terminal based on the device identifier in the watermark detection result.

20. The method according to claim 13, wherein, in the forwarding, audio data acquired by the first terminal is not forwarded to the second terminal and audio data acquired by the second terminal is not forwarded to the first terminal.
